(19) United States
(12) Patent Application Publication
(10) Pub. No.: US 2008/0068338 A1
(43) Pub. Date: Mar. 20, 2008

(54) MOUSE DEVICE

(75) Inventors: Chun-Chung Huang, Taipei (TW); Wen-Chun Liao, Taipei County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 11/857,415

(22) Filed: Sep. 18, 2007

(30) Foreign Application Priority Data
Sep. 18, 2006 (TW) TW95134424

(51) Int. Cl. G06F 3/033

(52) U.S. Cl. 345/164

(57) ABSTRACT

A mouse device. A circuit board is disposed on a bottom cover and includes an encoder, a first switch, and a second switch opposite the first switch. A support base is movably disposed on the bottom cover and wiggles with respect thereto. The support base is disposed between the first and second switches and includes a first retardant portion and a second retardant portion. The first retardant portion opposes the first switch. The second retardant portion opposes the second switch. A roller pivots on the support base and includes a shaft hole. A rotating shaft engages the shaft hole and connects to the encoder. A first gap exists between the rotating shaft and the shaft hole. The roller and support base wiggle with respect to the rotating shaft by the first gap, forcing the first retardant portion or second retardant portion to press the first switch or second switch.

### BACKGROUND OF THE INVENTION

1. Field of the Invention

The invention relates to a mouse device, and in particular to a mouse device providing effort-saving effects.

2. Description of the Related Art

Generally, a four-directional roller mechanism of a conventional mouse can provide operations of rotation, downward movement, and leftward and rightward wiggle. To provide the operation of the leftward and rightward wiggle, the four-directional roller mechanism often has a complicated structure. Manufacture of the four-directional roller mechanism is thus difficult. Moreover, operation of the four-directional roller mechanism is not easy. Namely, a large force is needed to drive the four-directional roller mechanism to wiggle leftward and rightward, causing inconvenience of operation.

Hence, there is a need for a mouse device with a simplified four-directional roller mechanism and effort-saving effects.

### BRIEF SUMMARY OF THE INVENTION

A detailed description is given in the following embodiments with reference to the accompanying drawings.

An exemplary embodiment of the invention provides a mouse device comprising a bottom cover, a circuit board, a support base, a roller, and a rotating shaft. The circuit board is disposed on the bottom cover and comprises an encoder, a first switch, and a second switch opposite the first switch. The support base is movably disposed on the bottom cover and wiggles with respect thereto. The support base is disposed between the first and second switches and comprises a first retardant portion and a second retardant portion. The first retardant portion opposes the first switch. The second retardant portion opposes the second switch. The roller pivots on the support base and comprises a shaft hole. The rotating shaft is engaged in the shaft hole of the roller and connected to the encoder. A first gap exists between the rotating shaft and the shaft hole. The roller and support base wiggle with respect to the rotating shaft by the first gap, forcing the first retardant portion of the support base to press the first switch or the second retardant portion thereof to press the second switch.

The rotating shaft comprises an encoding end and a shaft body. The encoding end is connected to the shaft body and disposed in the encoder. The shaft body is engaged in the shaft hole of the roller. The first gap exists between the shaft body and the shaft hole.

A second gap exists between the encoding end and an engaging hole of the encoder. The roller and support base wiggle with respect to the rotating shaft by the first and second gaps.

The shaft body comprises an engaging portion. The shaft hole comprises an engaging groove. The profile of the engaging portion is complementary to that of the engaging groove.

The circuit board further comprises a third switch. The support base further comprises a third retardant portion opposing the third switch. The roller, support base, and rotating shaft move with respect to the bottom cover, forcing the third retardant portion to press the third switch.

The mouse device further comprises a resilient member connecting the support base to the circuit board, providing the support base with restoring resilience.

### BRIEF DESCRIPTION OF THE DRAWINGS

The invention can be more fully understood by reading the subsequent detailed description and examples with references made to the accompanying drawings, wherein:

FIG. 1 is a schematic top view of a mouse device;

FIG. 2 is an exploded perspective view of the mouse device;

FIG. 3 is a schematic side view of a roller of the mouse device;

FIG. 4 is a schematic perspective view of a rotating shaft of the mouse device; and

FIG. 5 is a schematic perspective view of a four-directional roller mechanism of the mouse device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

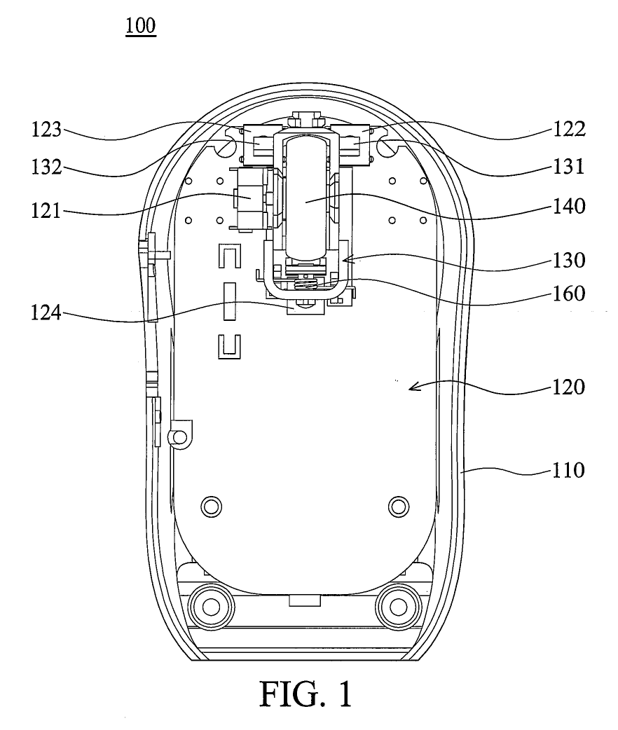

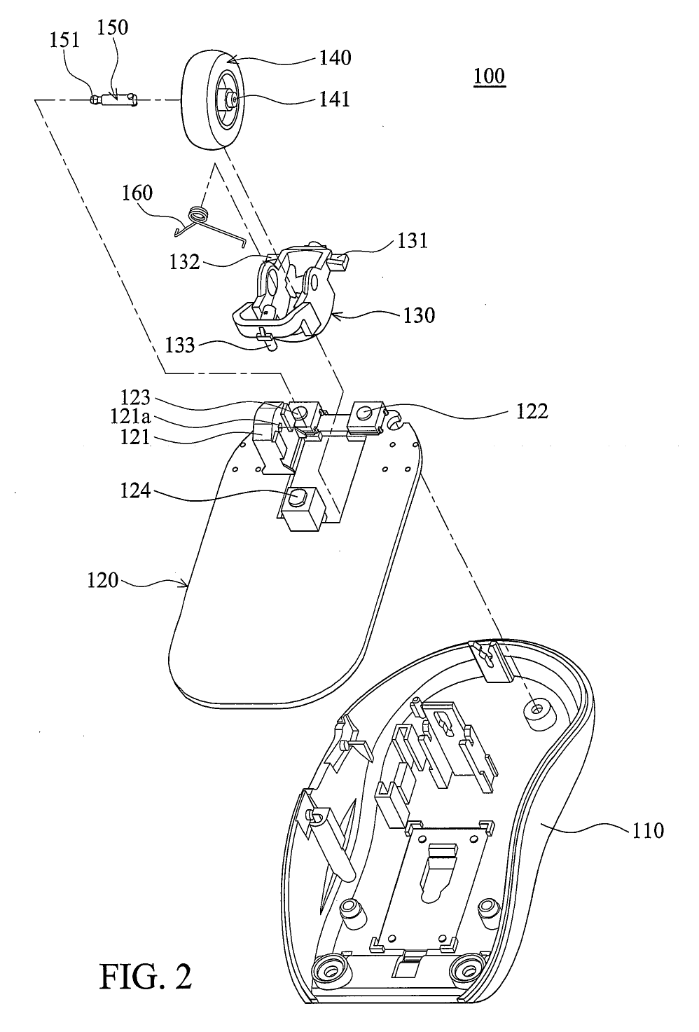

Referring to FIG. 1 and FIG. 2, a mouse device 100 comprises a bottom cover 110, a circuit board 120, a support base 130, a roller 140, a rotating shaft 150, and a resilient member 160. Here, the support base 130, roller 140, and rotating shaft 150 form a four-directional roller mechanism.

The circuit board 120 is disposed on the bottom cover 110 and comprises an encoder 121, a first switch 122, a second switch 123, and a third switch 124. The first switch 122 is opposite the second switch 123.

The support base 130 is movably disposed on the bottom cover 110 and wiggles with respect thereto. The support base 130 protrudes from the circuit board 120 and is disposed between the first switch 122 and the second switch 123. Specifically, the support base 130 comprises a first retardant portion 131, a second retardant portion 132, and a third retardant portion 133. The first retardant portion 131, second retardant portion 132, and third retardant portion 133 oppose the first switch 122, second switch 123, and third switch 124, respectively.

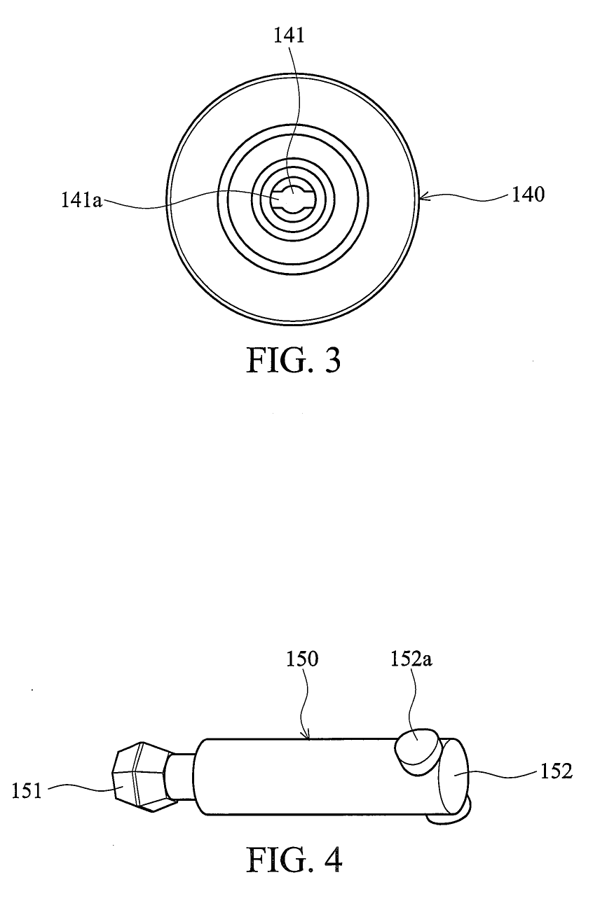

The roller 140 pivots on the support base 130. Specifically, as shown in FIG. 3, the roller 140 comprises a shaft hole 141, and the shaft hole 141 comprises an engaging groove 141a.

As shown in FIG. 2, the rotating shaft 150 is engaged in the shaft hole 141 of the roller 140 and connected to the encoder 121, driving a rotating member (not shown) disposed in the encoder 121 to rotate. Specifically, as shown in FIG. 4, the rotating shaft 150 comprises an encoding end 151 and a shaft body 152. The encoding end 151 is connected to the shaft body 152 and engaged in an engaging hole 121a of the encoder 121. The shaft body 152 is engaged in the shaft hole 141 of the roller 140. Specifically, a first gap exists between the shaft body 152 of the rotating shaft 150 and the shaft hole 141 of the roller 140 and a second gap exists between the encoding end 151 of the rotating shaft 150 and the engaging hole 121a of the encoder 121. Moreover, as shown in FIG. 3 and FIG. 4, the shaft body 152 of the rotating shaft 150 comprises an engaging portion 152a. The profile of the engaging portion 152a is complementary to that of the engaging groove 141a of the shaft hole 141 of the roller 140. Accordingly, when the rotating shaft 150 is engaged in the shaft hole 141 of the roller 140, the engaging portion 152a of the shaft body 152 is engaged in the engaging groove 141a of the shaft hole 141. The rotating shaft 150 can thus rotate with the roller 140.

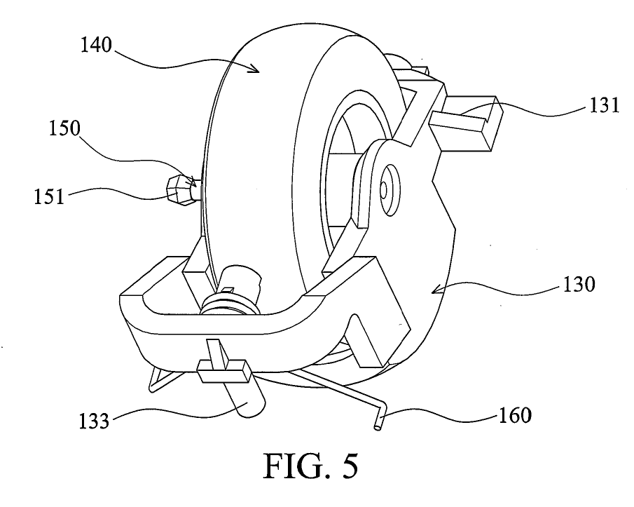

As shown in FIGS. 1, 2, and 5, the resilient member 160 connects the support base 130 to the circuit board 120. In this embodiment, the resilient member 160 may be a torsion spring.

The following description is directed to operation of the mouse device 100 or four-directional roller mechanism (support base 130, roller 140, and rotating shaft 150) thereof.

First, the roller 140 can be rotated (by a finger of a user) to perform scrolling operations. At this point, the encoding end 151 of the rotating shaft 150 rotates in the encoder 121. The encoder 121 detects a rotating angle of the roller 140 or rotating shaft 150 and thereby performs corresponding vertical scrolling in a window on a screen.

In another aspect, the roller 140 can be directly pushed (by the finger of the user). At this point, the support base 130, roller 140, and rotating shaft 150 move with respect to the bottom cover 110, enabling the third retardant portion 133 of the support base 130 to press the third switch 124. The mouse device 100 can thus perform a corresponding operation, such as double click. Specifically, as the resilient member 160 connects the support base 130 to the circuit board 120, the support base 130, roller 140, and rotating shaft 150 can easily return to their original positions by restoring resilience provided by the resilient member 160 and provide the user with smooth operation.

In another aspect, the roller 140 can be wiggled (by the finger of the user). At this point, as the first gap exists between the shaft body 152 of the rotating shaft 150 and the shaft hole 141 of the roller 140 and the second gap exists between the encoding end 151 of the rotating shaft 150 and the engaging hole 121a of the encoder 121, the roller 140 and support base 130 can wiggle with respect to the rotating shaft 150 thereby. Here, the roller 140 does not interfere with the rotating shaft 150. For example, when the roller 140 and support base 130 wiggle rightward, the first retardant portion 131 of the support base 130 presses the first switch 122 of the circuit board 120, enabling the mouse device 100 to perform a corresponding operation, such as rightward lateral scrolling in the window on the screen. On the other hand, when the roller 140 and support base 130 wiggle leftward, the second retardant portion 132 of the support base 130 presses the second switch 123 of the circuit board 120, enabling the mouse device 100 to perform another corresponding operation, such as leftward lateral scrolling in the window on the screen.

In conclusion, the disclosed mouse device or four-directional roller mechanism thereof can perform four-directional operations with a simplified structure and provide effort-saving effects.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mouse device, comprising:
a bottom cover;
a circuit board disposed on the bottom cover and comprising an encoder, a first switch, and a second switch opposite the first switch;
a support base movably disposed on the bottom cover and wiggling with respect thereto, wherein the support base is disposed between the first and second switches and comprises a first retardant portion and a second retardant portion, the first retardant portion opposes the first switch, and the second retardant portion opposes the second switch;
a roller pivoting on the support base and comprising a shaft hole; and
a rotating shaft engaged in the shaft hole of the roller and connected to the encoder, wherein a first gap exists between the rotating shaft and the shaft hole, and the roller and support base wiggle with respect to the rotating shaft by the first gap, forcing the first retardant portion of the support base to press the first switch or the second retardant portion thereof to press the second switch.

2. The mouse device as claimed in claim 1, wherein the rotating shaft comprises an encoding end and a shaft body, the encoding end is connected to the shaft body and disposed in the encoder, the shaft body is engaged in the shaft hole of the roller, and the first gap exists between the shaft body and the shaft hole.

3. The mouse device as claimed in claim 2, wherein a second gap exists between the encoding end and an engaging hole of the encoder, and the roller and support base wiggle with respect to the rotating shaft by the first and second gaps.

4. The mouse device as claimed in claim 2, wherein the shaft body comprises an engaging portion, the shaft hole comprises an engaging groove, and the profile of the engaging portion is complementary to that of the engaging groove.

5. The mouse device as claimed in claim 1, wherein the circuit board further comprises a third switch, the support base further comprises a third retardant portion opposing the third switch, and the roller, support base, and rotating shaft move with respect to the bottom cover, forcing the third retardant portion to press the third switch.

6. The mouse device as claimed in claim 5, further comprising a resilient member connecting the support base to the circuit board, providing the support base with restoring resilience.
